(19) United States
(12) Patent Application Publication
(10) Pub. No.: US 2021/0328779 A1
(43) Pub. Date: Oct. 21, 2021

(54) METHOD AND APPARATUS FOR FAST SYMMETRIC AUTHENTICATION AND SESSION KEY ESTABLISHMENT

(71) Applicant: Intel Corporation, Santa Clara, CA (US)

(72) Inventor: Xiaoyu Ruan, Folsom, CA (US)

(73) Assignee: Intel Corporation, Santa Clara, CA (US)

(21) Appl. No.: 17/358,604

(22) Filed: Jun. 25, 2021

(51) Int. Cl. H04L 9/08; H04L 9/32

(52) U.S. Cl. CPC H04L 9/0825; H04L 9/3242; H04L 9/0894; H04L 9/0869

(57) ABSTRACT

The disclosure provides method, system and apparatus to provide authentication between one or more endpoints during an initial and subsequent boot cycles. In an exemplary application, an asymmetric-key cryptography is used only once to set up a persistent seed between the host and the device. After the initial setup, symmetric-key cryptography may be used with the agreed seed for authentication and session key establishment. The device wraps the persistent seed with device secrets and stores it on the host, hence secure NVM is not required on the device. The disclosed embodiments are particularly advantageous over the art of record as they provide authentications speeds of over 20,000 times faster than asymmetric-key cryptography.

### FIELD

The instant disclosure generally relates to system, method and apparatus for fast symmetric authentication and session key establishment. In one embodiment, the disclosure provides method, system and apparatus to provide authentication between one or more endpoints during an initial and subsequent boot cycles.

### BACKGROUND

In conventional applications a host device typically communicates with one or more endpoints (interchangeably, devices). The endpoints may include peripheral devices may include, for example, cameras, detectors and fingerprint sensors. A host must authenticate the endpoint prior to communicating data therewith. Similarly, the endpoint may require authentication of the host prior to sending data thereto. In an example where the endpoint is a fingerprint sensor, the host and the endpoint sensor may require mutual authentication before sensitive data is exchanged.

The state-of-the-art of authentication and session key establishment between a host and an endpoint device is inefficient because it uses slow and expensive asymmetric-key cryptography. The conventional authentical techniques also require storage device at both the host and the endpoint to expedite asymmetric authentication. Since many of the conventional low-cost endpoints do not include a secure device memory (e.g., the Systems-on-Chip (SoC) may not have a secure memory), each subsequent authentication sessions require longer authentication.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically illustrates the phases of an exemplary implementation of the disclosure.

FIG. 2 is a flow diagram for setting authentication parameters according to one embodiment of the disclosure.

FIG. 3 is a schematic representation of a start-up process according to one embodiment of the disclosure.

FIG. 4 is an exemplary flow diagram for an enrolment flow with asymmetric encryption where host authenticates the end device.

FIG. 5 is an exemplary flow diagram for asymmetric encryption for mutual authentication.

FIG. 6 is an exemplary flow diagram according to one embodiment of the disclosure for enrollment with Elliptic-curve Diffie-Hellman Ephemeral (ECDHE) and one-way authentication.

FIG. 7A schematically illustrates an exemplary implementation of enrollment flow with ECDHE and mutual authentication.

FIG. 7B is a continuation of FIG. 7A.

FIG. 8 schematically illustrates symmetric authentication and session key establishment flow run on every boot according to one embodiment of the disclosure.

FIG. 9 is an exemplary computing system configured to implement a disclosed embodiment.

### DETAILED DESCRIPTION

The disclosed embodiment overcomes the long authentication session required between the host and an endpoints (particularly during subsequent authentications) by employing symmetric-key cryptography. Importantly, the disclosed embodiments do not require secure storage on the device.

Previous protocols for device-to-host authentication and session key establishment are described in multiple industry standards, such as USB type C/PCIe security enhancement specification (https://wwwintel.com/content/www/us/en/io/pci-express/pcie-device-security-enhancements-spec.html), Microsoft's Cerberus protocol (https://github.com/opencomputeproject/Project_Olympus/blob/master/Project_Cerberus/Project%20Cerberus%20Challenge%20Protocol.pdf), and SPDM (https://www.dmtf.org/dsp/DSP0274). There are also other protocols designed for network communications that perform authentication and session key establishment.

The conventional USB/PCIe security protocol and Cerberus require asymmetric-key cryptography at every boot. A large number of devices are typically available on each platform. For example, in the Cerberus, the platform root of trust connects with every device, including arrays of Solid-State Drives (SSDs). Asymmetric-key cryptography is power intensive and slow especially for constrained devices. To overcome this and other deficiencies of the conventional techniques, the disclosed embodiments perform asymmetric-key cryptography only at first boot and use symmetric-key cryptography at subsequent boots.

While each of the Transport Layer Security (TLS) and Security Protocol Data Model (SPDM) cryptography protocols use a pre-shared key (PSK) to eliminate asymmetric-key cryptography at every boot, the endpoints are required to have a secure non-volatile memory (NVM) in order to store the PSK. Many conventional endpoint devices, including some core CPUs, do not have secure NVM. To overcome this and other deficiencies of the art, the disclosed embodiments require NVM at only one endpoint. The endpoint may be a host or an endpoint device. In this regard it should be noted that a memory device is different from the conventional physically-unclonable functions (PUF) which are conventionally used for secure key generation. The conventional systems which rely on PUF do not have NVM; rather they only generate a PUF based on the device's anomalies. The disclosed embodiments are also distinguishable from conventional Device Identifier Encryption Engine (DICE) as DICE is directed to generating device certificate chain while the disclosed principles related to session key establishment (which can use any certificate chain regardless of DICE).

Thus, an exemplary embodiment uses asymmetric-key cryptography only once to set up a persistent seed between the host and the device. After the initial setup, symmetric-key cryptography (over 20,000 times faster than asymmetric-key cryptography) may be used with the agreed seed for authentication and session key establishment. The device wraps the persistent seed with device secrets and stores it on the host, hence secure NVM is not required on the device.

The disclosed embodiments are advantageous over the conventional methods. For example, the disclosed embodiments significantly expedite authentication and session key establishment by over 20,000 times faster than the protocols currently deployed in hundreds of millions of devices without requiring additional hardware (i.e., NVM) capability. The increased speed offer consumers much lower cost and greater (faster) experience. The disclosed embodiments are also significantly more energy efficient which increases battery life, thereby enhancing the customer experience.

In addition, certain protocols require the link between System-on-Chip (SoC) and the peripherals (e.g., FPGA) to be protected. This requires storing the PSK on the SoC's NVM. However, most conventional SoCs do not have NVM and cannot store the PSK. The disclosed embodiments satisfy the protocol requirements without requiring a local NVM on the SoC.

Table 1 shows host and endpoint prerequisites for an exemplary implementation of the disclosed principles. It should be noted that the exemplary requirements are the same as those available in the conventional systems (e.g., Cerberus) and do not require system modification. That is, the disclosed embodiments boost performance and reduces power consumption without requiring additional capability.

TABLE
Host and endpoint (device) capability requirements

| Capability | Required on Host? | Required on Device? |
|---|---|---|
| Secure NVM | Yes | No |
| Asymmetric crypto | Yes | Yes |
| (e.g., RSA or ECC) | | |
| Symmetric crypto (hash, | Yes | Yes |
| MAC, AES) | | |
| DRNG | Yes | Yes, if Device |
| | | requires Host |
| | | authentication or |
| | | Diffie-Hellman for |
| | | enrollment; |
| | | No, otherwise |
| Private key and certificate | Yes, if Device requires | Yes |
| chain rooted to a trust | Host authentication; | |
| anchor. The credential | No, otherwise | |
| must be unique per device. | | |

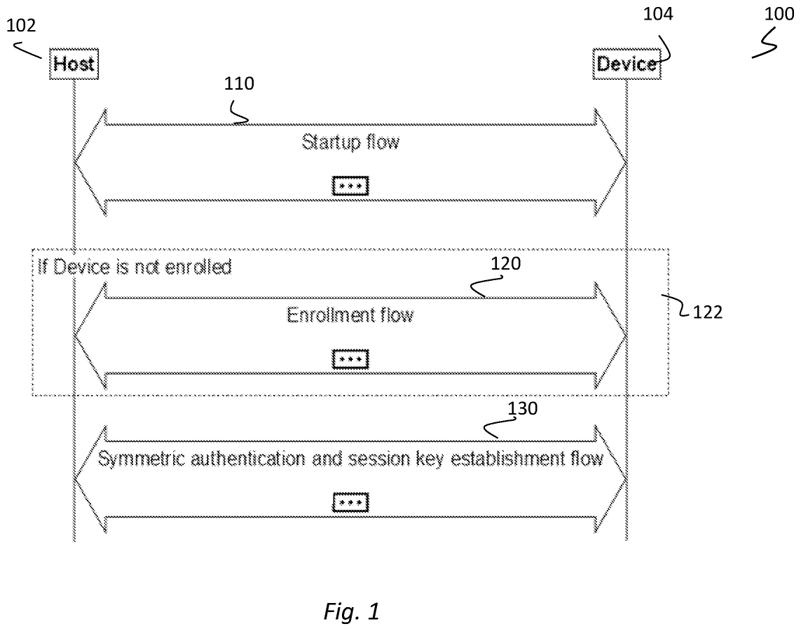

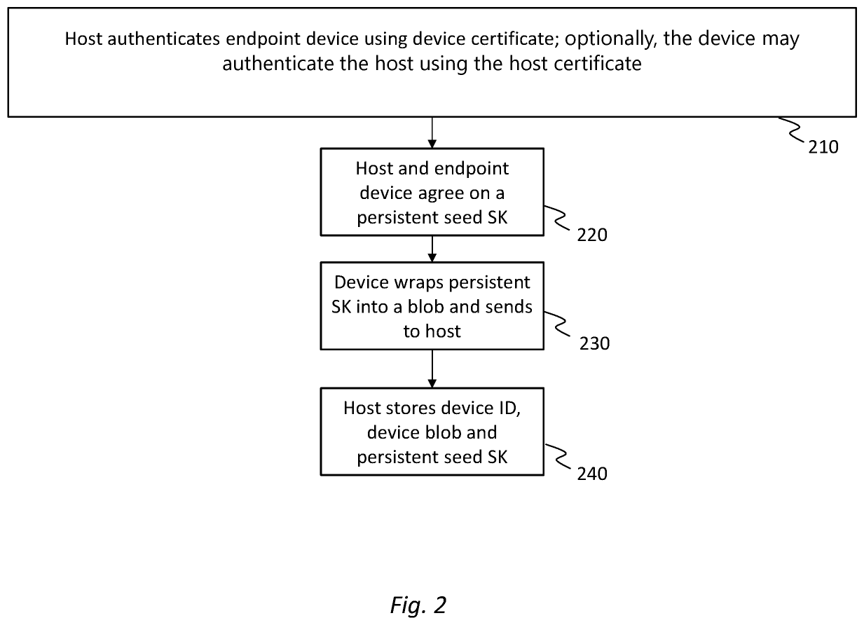

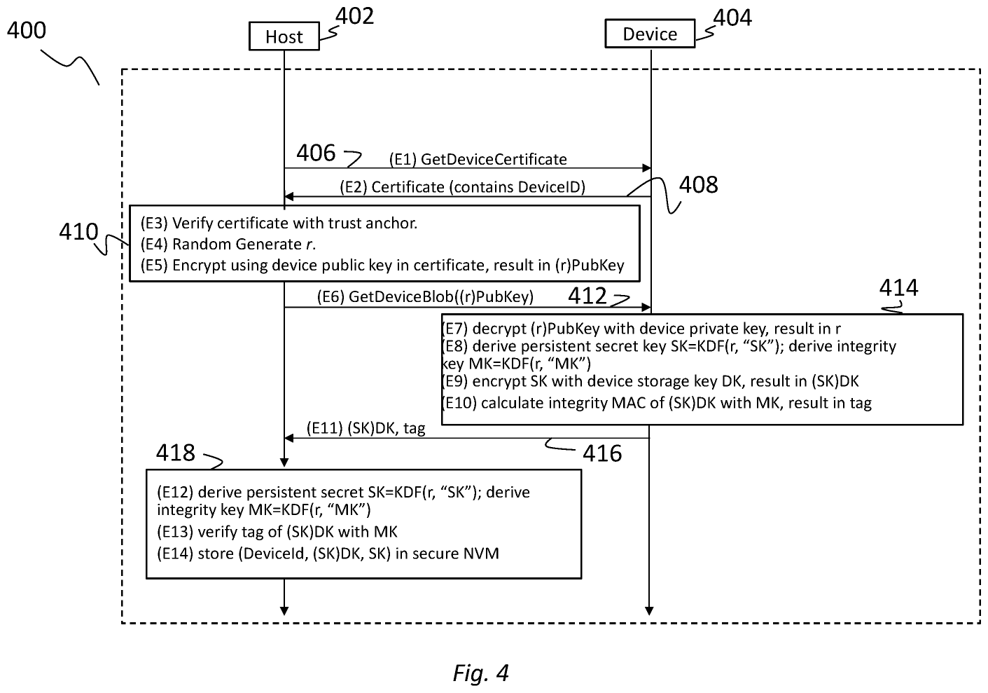

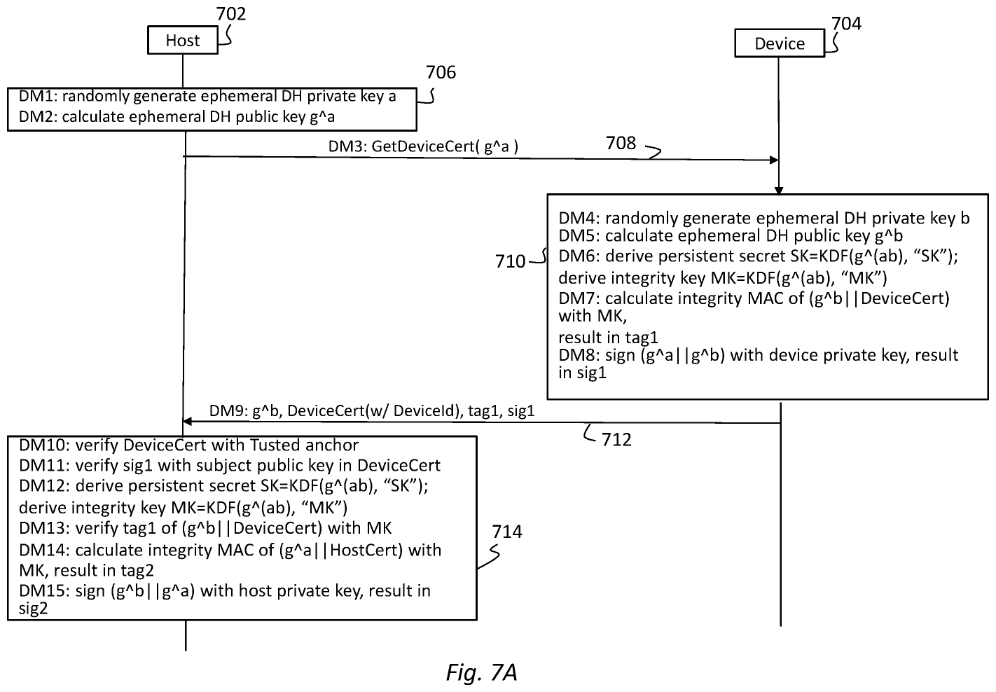

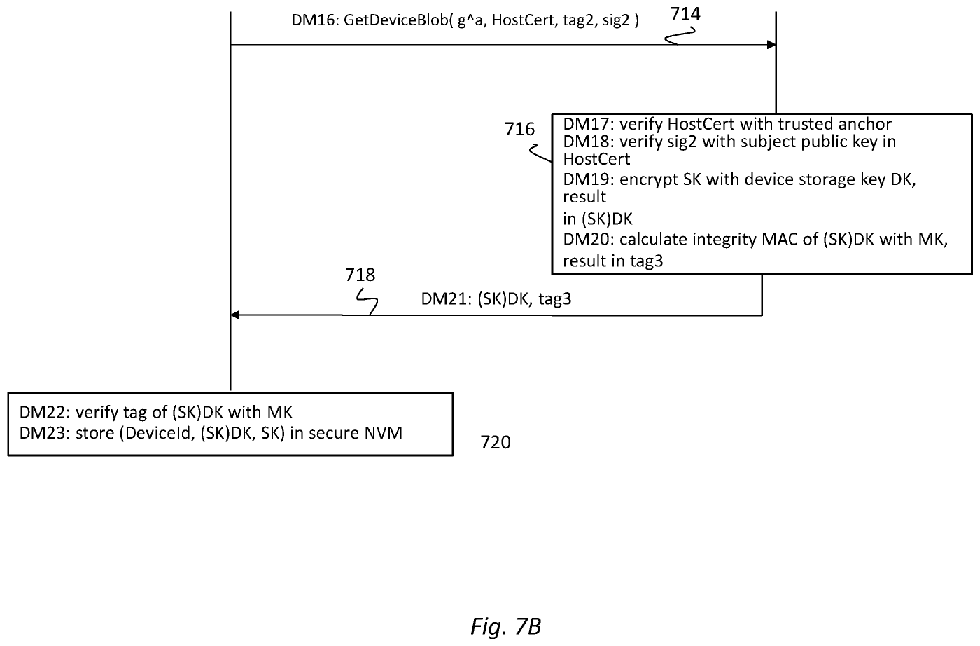

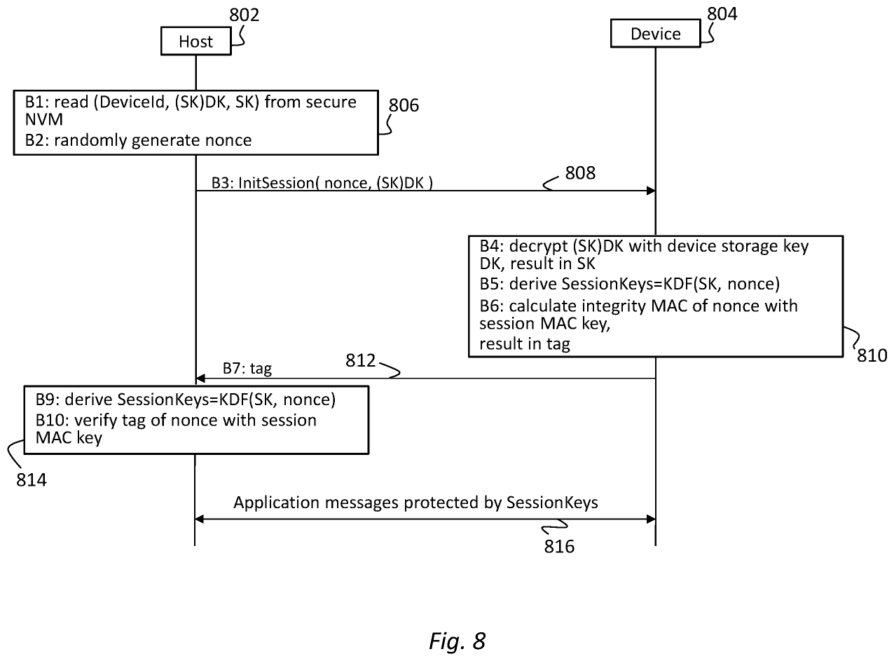

FIG. 1 schematically illustrates the phases of an exemplary implementation of the disclosure. Specifically, phase diagram 100 of FIG. 1 shows host 102 and endpoint device 104 in communication. Host 102 and endpoint 104 may be formed on the same integrated circuit (IC) or may be located at different ICs. The exemplary process of FIG. 1 may include three phases. As schematically illustrated in FIG. 1, the phases may include the startup phase 110, the enrolment phase 120 and symmetric authentication and session key establishment flow 130. At startup phase 110, Host 102 receives Device ID from endpoint device 104. This process is further described in relation to FIG. 2. At enrollment phase 120 endpoint device 104 registers with host 102. Enrolment phase 120 is further described in relation to FIGS. 4 and 7 (below). At symmetric authentication and session key establishment phase 130, endpoint device 104 and the host 102 perform session key establishment. This phase is further discussed in relation to FIG. 8 (below).

If after the startup phase 110, host 102 does not find existing record of endpoint device 104 (as illustrated by dashed line 122), then host 102 may optionally run the enrollment flow algorithm of FIG. 2. The algorithm of FIG. 2 may be implemented, for example, at the first time a host authenticates an endpoint device. It should be noted that the host can also be an endpoint device. Thus, this technique may be used anytime an endpoint device is new and needs authentication.

At step 210, the host authenticates the endpoint device using the endpoint device's certificate. The device may also authenticate the host. A device certificate is a unique identifier used to authenticate any device or part of an integrated device. A device certificate may be associated with a processor, an IC, an SoC or a system. Device certificates are factory installed by vendors during the manufacturing process and are unique to each device.

At step 220 the host and the endpoint device agree on a persistent seed Shared Key (SK). Any of the conventional method for arriving at a shared key may be used. By way of example, a persistent seed SK may be created by pseudo-random number generator (PRNG) on the host and sent to the device in encrypted form. The seed SK may also be agreed upon by the host and the endpoint using key-agreement schemes such as ECDHE.

At step 230 the endpoint device wraps the persistent seed SK into a blob with the device's unique storage key and send the combination to the host for storage. An added uniform random blob is a discipline for encrypted data formats designed to minimize unintended information leakage either from its encryption format metadata or from its total length. A blob's content may be indistinguishable from a uniform random bit string to a potential observer without a relevant decryption key. A blob leaks no information through headers or other cleartext metadata associated with the encrypted data format. The blob may then be transmitted from the endpoint device to the host. Finally, at step 240, the host stores the device ID, device blob and the persistent seed in its NVM.

Referring again to FIG. 1, after startup phase 110, if the host finds a record of the device, then it runs the symmetric authentication and session key establishment flow 130. In one implementation, the symmetric authentication and session key establishment flow 130 includes the following steps. First, host 102 sends endpoint device 104 blob (stored from step 240, FIG. 2) to the endpoint device. Next, endpoint device 104 recovers the persistent seed SK from the blob by decrypting the blob with the device's unique storage key. Finally, host 102 and endpoint device 104 establish session keys from the persistent seed SK and nonces.

Startup Flow

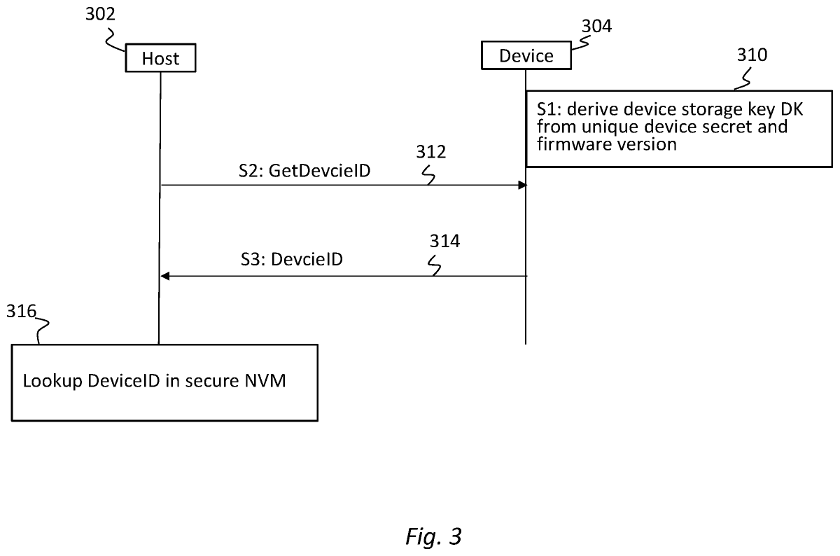

FIG. 3 schematically illustrates an exemplary startup flow according to one embodiment of the disclosure. The startup phase may be implemented if the host and the endpoint device are coming out of reset or if they are new to the system. At startup step 310, Device 304 derives deice storage key DK from unique device secret and firmware version. That is, out of reset, device 304 (which may be a host device or an endpoint device) generates an Advanced Encryption Standard (AES) storage key DK from a secret that is unique to this instance of device 304 and specific to the version n of device firmware (FW). The secret may be, for example, the device's private key (e.g., DICE alias key for Cerberus), as the device may already have a private key for authentication. Similar to the device private key, DK should change per FW version n. In certain implementations, this helps prevent older and possibly vulnerable FW from accessing secrets generated by newer FW.

At step 312, in message S2, host 302 asks endpoint device 304 for its DeviceId. At step 314 endpoint device 304 sends a response including DeviceId to host 302. It should be noted that no authentication is done in this exemplary algorithm yet. Host 302 looks up in its NVM to find the DeviceId as schematically shown in step 316. If DeviceId is found in NVM, then host 302 may run Symmetric Authentication and Session Key Establishment flow shown in FIG. 8. Otherwise, host 304 may run Enrollment flow shown in FIG. 4 or FIG. 7.

Enrolment Flow

While other implementations are possible without departing from the disclosed principles, for brevity, the disclosure provides two exemplary methods to perform enrollment. Certain principles are common to both methodologies: the endpoint device uses its device storage key DK to wrap a shared persistent seed SK. The wrapped SK and an integrity tag for the wrapped SK are sent to the host for storage. Future authentication is achieved by the device proving that it can unwrap and get to the correct SK. When endpoint device FW is updated, new DK may be derived, and the enrollment flow run again.

Option 1—Using Asymmetric Encryption to Transmit Seed.

In option 1, the host generates a random number, encrypts with the endpoint device's public key, and sends it to the device. FIG. 4 shows an exemplary embodiment of the enrolment algorithm according to one embodiment of the disclosure where device is not found in NVM of the host and asymmetric-key encryption is used. The algorithm of FIG. 4 may be run once for a new FW version and rerun after FW is updated. The persistent seed SK is derived from the random number. Steps E1 to E14 are described in flow diagram 400 of FIG. 4. At step 406, host 402 communicates enrolment flow message 406 to endpoint device 404 requesting device certificate from device 404. At 408 (E2) endpoint device 404 responds with device certificate which includes deviceID.

At step 410, host 402 verifies the device certificate against the trust anchor (E3). The trust anchor is the root certificate of the device's certificate chain. At step 410, host 402 also random generates r (E4) and encrypts r using device public key in certificate (E5); this results in (r)PubKey. At step 412, host 402 transmits message E6 which is a request for DeviceBlob((r)PubKey).

Once this request is received, endpoint device 404 decrypts (r)PubKey with device private key, result in r (step E7). Endpoint device 404 also derives persistent secret SK=KDF(r, “SK”); derives integrity key MK=KDF(r, “MK”) (Step E8); encrypts SK with device storage key DK, result is (SK)DK (as illustrated in step E9); calculates integrity MAC of (SK)DK with MK, result in tag (as illustrated in step E10). At step 416, endpoint device 404 communicates (SK)DK and tag to host 402. In the above arguments, MAC (or tag) is the Message Authentication Code, SK is the shared Secret Key, DK is the Device Storage Key and KDF is the Key Derivation Function.

At step 418, host 402 implements the following steps: derive persistent secret SK=KDF(r, “SK”) and derive integrity key MK=KDF(r, “MK”) (step E12); verify tag of (SK)DK with MK (as illustrated in step E13); and store (DeviceId, (SK)DK, SK) in secure NVM of host 402 (as illustrated in step E14).

In one exemplary implementation, at step 410 (sub-step E5), if the device certificate's subject public key is RSA, then host 402 may use RSA encryption; if it is ECC key, then host 402 may use ECIES encryption. Although the unauthenticated host chooses r, the scheme is not vulnerable to chosen plaintext attack against DK, because at step E9, anything encrypted by endpoint device is a one-way derivation SK of r, not the r itself.

Steps E9, E10 and E11 represent some of the disclosed principles of the disclosure. The device encrypts SK with DK that is known to only the device FW. The encryption of SK may use an AEAD (Authenticated Encryption with Associated Data) scheme such as GCM, or another encryption scheme. The resultant DeviceBlob is sent to the host in message E11 for storage. The DeviceBlob is opaque to the host—the host does not understand or consume DeviceBlob but stores it on behalf of the device as the device has no NVM.

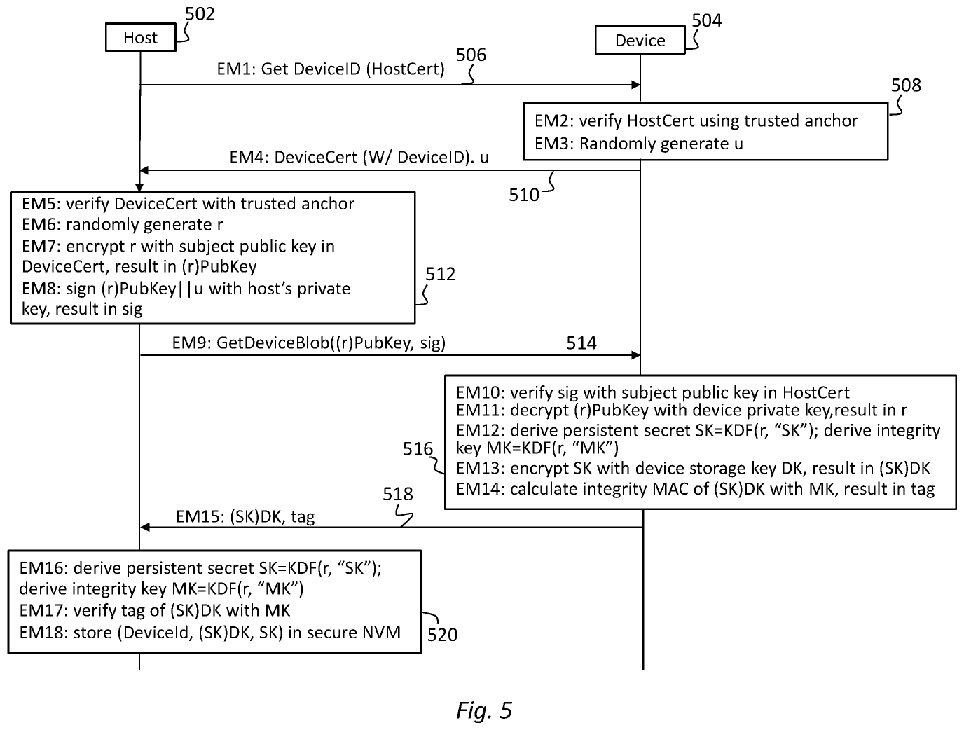

In certain embodiments, the endpoint device requires host 402 to authenticate, for example, if the device is a fingerprint sensor that captures sensitive user fingerprint, to make sure host 402 is a trusted host before sending out information. FIG. 5 shows the enrollment flow for mutual authentication.

Specifically, FIG. 5 shows an enrollment process when DeviceID is not found in VM and when asymmetric-key encryption and signature are used for mutual authentication. The flow diagram of FIG. 5 may be run once for a new FW version and/or rerun after an FW update. In FIG. 5, host 502 requests DeviceID (HostCert) at step EM1. Host 502 may include its host certificate in the request message EM1.

Endpoint device 504 verifies the host's certificate (HostCert) using trusted anchor (step EM2) and randomly generates u, where u is the device's nonce that the host will sign to authenticate to the device.

Endpoint device 504 then sends DeviceCert with DeviceID and u back to host 502. Using this information, host 502 verifies DeviceCert with trusted anchor (step EMS), randomly generates r (step EM6), encrypts r with subject public key in DeviceCert which results in (r)PubKey (step EM7) and signs (r)PubKey concatenated with u with host's private key which results in the signature (step E8). Next, host 502 transmits to endpoint device 504 signature: GetDeviceBlob((r)PubKey, sig) as indicated by arrow 514. Endpoint device 516 verifies this signature with subject public key in HostCert (step EM10); decrypts (r)PubKey with device private key, result in r (step EM11), derives persistent secret SK=KDF(r, “SK”), derives integrity key MK=KDF(r, “MK”)(step EM12); encrypt SK with device storage key DK, result in (SK)DK (Step EM13); and calculate integrity MAC of (SK)DK with MK, result in tag (step EM14).

Endpoint device 504 sends (SK)DK, tag to host 502 as show at step 518. Host 502 then: derives persistent secret SK=KDF(r, “SK”) and integrity key MK=KDF(r, “MK”) (step EM16); verifies tag of (SK)DK with MK (step EM17) and stores (DeviceId, (SK)DK, SK) in secure NVM (step EM18).

It should be noted that while the exemplary embodiments reflect a host and an endpoint device, the discloses principles may be applied to two endpoints equally.

Option 2—Use ECDHE to Agree on Persistent Seed.

Elliptic-curve Diffie-Hellman (ECDH) is a key agreement protocol that allows two parties, each party having an elliptic-curve public-private key pair, to establish a shared secret over an insecure channel. This shared secret may be directly used as a key or to derive another key. ECDH Ephemeral (ECDHE) uses elliptic curve Diffie-Hellman key exchange. This exchange is signed with RSA or ECDSA.

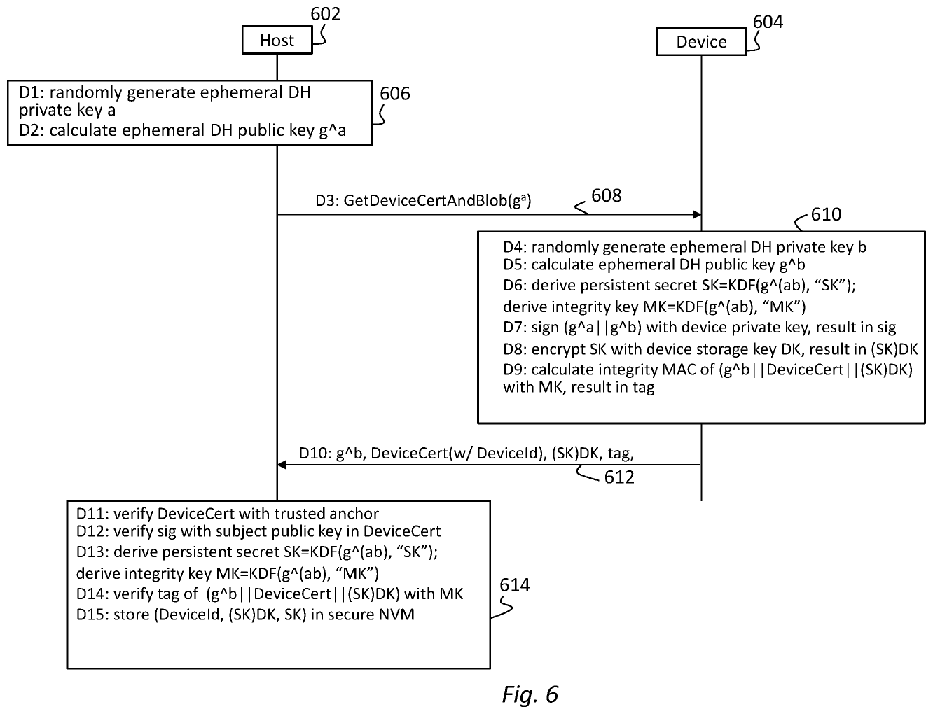

FIG. 6 is an exemplary flow diagram according to one embodiment of the disclosure for enrollment with ECDHE and one-way authentication. The flow diagram of FIG. 6 runs once for a device FW version and may rerun after a device firmware update. In this option 2, the host and the device agree on SK using the ephemeral Diffie-Hellman scheme. Authentication of the device is done after the ECDHE session, at step D11. FIG. 6 shows the use of one-way authentication.

The process starts at step 606 when host 602 randomly generates ephemeral DH private key a (step D1) and calculates ephemeral DH public key g\hat{ }a (step D2). Next, host 602 communicates to endpoint device 604: GetDeviceCertAndBlob(g^{a}) as indicated by arrow 608.

At step 608, end device 604 performs a series of steps as follows: randomly generate ephemeral DH private key b (step D4); calculate ephemeral DH public key g\hat{ }b (step D5); derive persistent secret SK=KDF(g\hat{ }(ab), “SK”) and derive integrity key MK=KDF(g\hat{ }(ab), “MK”) (step D6); sign (g\hat{ }a∥g\hat{ }b) with device private key, result in sig (Step D7); encrypt SK with device storage key DK, result in (SK)DK (Step D8); calculate integrity MAC of (g\hat{ }b∥DeviceCert∥(SK)DK) with MK, result in tag (Step D9). Endpoint device 604 then transmits the following to host 602: g\hat{ }b, DeviceCert(w/ DeviceId), (SK)DK, tag (step 612) as indicated by arrow 614. Host 602 verifies the information and stores (DeviceId, (SK)DK, SK) in secure NVM.

FIG. 7A schematically illustrates an exemplary implementation of enrollment flow with ECDHE and mutual authentication. The process of FIG. 7A starts when host 702 randomly generates ephemeral DH private key a (step DM1) and calculates ephemeral DH public key g^{a} (step DM2). Host 702 then transmits to device 704 a request for GetDeviceCert(g^{a}) as indicated by arrow 708. Endpoint device 704 then performs tasks DM4-DM8 as indicated in box 710. These steps include randomly generate ephemeral DH private key b (step DM4); calculate ephemeral DH public key g\hat{ }b (step DM5); derive persistent seed SK=KDF(g\hat{ }(ab), “SK”) and derive integrity key MK=KDF(g\hat{ }(ab), “MK”)(step DM6); calculate integrity MAC of (g\hat{ }b∥DeviceCert) with MK, result in tag1 (step DM7); sign (g\hat{ }a∥g\hat{ }b) with device private key, result in sig1 (step DM8).

Device 704 then transmits DM9: g\hat{ }b, DeviceCert(w/ DeviceId), tag1, sig1 to 702 Host as shown by arrow 712. In response, host 702 performs the followings tasks at process 714: verify DeviceCert with trusted anchor (DM10); verify sig1 with subject public key in DeviceCert (step DM11); derive persistent secret SK=KDF(g\hat{ }(ab), “SK”) (step DM12) and derive integrity key MK=KDF(g\hat{ }(ab), “MK”); verify tag1 of (g\hat{ }b∥DeviceCert) with MK (step DM13); calculate integrity MAC of (g\hat{ }a∥HostCert) with MK, result in tag2 (step DM14) and sign (g\hat{ }b|g\hat{ }a) with host private key, result in sig2 (step DM15). The continuation of FIG. 7A is shown at FIG. 7B.

At step 714, host 702 transmits the requests GetDeviceBlob(g\hat{ }a, HostCert, tag2, sig2 (step DM16). Endpoint device 704 then runs a series of algorithms as follows: verify HostCert with trusted anchor (step DM17); verify sig2 with subject public key in HostCert (step DM18); encrypt SK with device storage key DK, result in (SK)DK (step DM19); and calculate integrity MAC of (SK)DK with MK to result in tag3 (step DM20). The result is then communicated to host 702 as (SK)DK, tag3 (step DM21). Host 702 then verifies tag of (SK)DK with MK (step DM22) and stores (DeviceId, (SK)DK, SK) in secure NVM (step DM23)

Symmetric Authentication and Session Key Establishment Flow.

FIG. 8 schematically illustrates symmetric authentication and session key establishment flow which run on every boot where DeviceId is found in host's NVM according to one embodiment of the disclosure. The NVM may be a secure NVM. The process starts at step 806 where host 802 performs the following operations: read (DeviceId, (SK)DK, SK) from secure NVM (step B1) and randomly generate nonce (step B2). Host 802 then sends the nonce together with DeviceBlob back to the device in message B3 as indicated by arrow 808. Only the same device FW that constructed the DeviceBlob during Enrollment flow would be able to verify and decrypt DeviceBlob and arrive at SK. Note that alternating DeviceBlob by a rogue host or a man-in-the-middle attacker will be detected by the device in step B4.

Device 804 then performs the following processes: decrypt (SK)DK with device storage key DK, result in SK (step B4); derive SessionKeys=KDF(SK, nonce) (step B5); calculate integrity MAC of nonce with session MAC key, result in tag (step B6). At step B7, endpoint device 804 sends the tag to host 802 (step B7). Host 802 then performs the following operations: derive SessionKeys=KDF(SK, nonce) (step B9) and verify tag of nonce with session MAC key (step B10) as shows at 814. The symmetric authentication of the device is achieved by the device proving that it has the correct DK used in Enrollment to decrypt the DeviceBlob and get the correct SK. If the device did not have the right DK, then step B10 would fail as the SK used by the host and the device would not be the same. Failure of B10 could be caused by device FW update or an active attack. The host should run the Enrollment flow again.

Once B10 passes, the host and the device may continue secure communication with the established session keys. The persistent SK is never directly used to protect messages.

When mutual authentication is required, the host does not explicitly authenticate to the device in this flow. The host must have a matching SK from the Enrollment flow to derive the same session keys as the device. If the host does not have the SK, then the application messaging after step B10 will fail. At this point the application messages between host 802 and endpoint 804 are protected by SessionKeys as indicated by arrow 816.

In one embodiment, the device may be stateless. To further enhance security, host 802 may run enrollment flow periodically to renew SK, even if there is no failure at B10. It should be noted that the flow does not use slow asymmetric-key cryptography. This can boost performance over traditional methods by over 20,000 times and this is the main advantage of our solution.

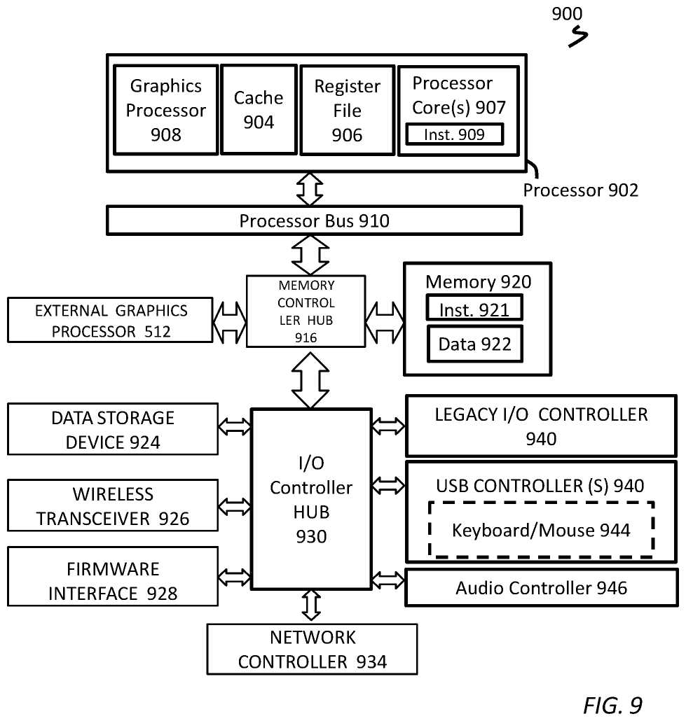

FIG. 9 is an exemplary computing system configured to implement a disclosed embodiment.

FIG. 9 is a block diagram of a processing system and an environment to implement the disclosed embodiments. System 900 of FIG. 9 may be used to implement one or more of the disclosed principles. In various embodiments the system 900 includes one or more processors 902 and one or more graphics processors 908, and may be a single processor desktop system, a multiprocessor workstation system, or a server system having a large number of processors 902 or processor cores 907. In on embodiment, the system 900 is a processing platform incorporated within a system-on-a-chip (SoC or SOC) integrated circuit for use in mobile, handheld, or embedded devices.

An embodiment of system 900 can include, or be incorporated within a server-based gaming platform, a game console, including a game and media console, a mobile gaming console, a handheld game console, or an online game console. In some embodiments system 900 is a mobile phone, smart phone, tablet computing device or mobile Internet device. Data processing system 900 can also include couple with, or be integrated within a wearable device, such as a smart watch wearable device, smart eyewear device, augmented reality device, or virtual reality device. In some embodiments, data processing system 900 is a television or set top box device having one or more processors 902 and a graphical interface generated by one or more graphics processors 908.

In some embodiments, the one or more processors 902 each include one or more processor cores 907 to process instructions which, when executed, perform operations for system and user software. In some embodiments, each of the one or more processor cores 907 is configured to process a specific instruction set 909. In some embodiments, instruction set 909 may facilitate Complex Instruction Set Computing (CISC), Reduced Instruction Set Computing (RISC), or computing via a Very Long Instruction Word (VLIW). Multiple processor cores 907 may each process a different instruction set 909, which may include instructions to facilitate the emulation of other instruction sets. Processor core 907 may also include other processing devices, such a Digital Signal Processor (DSP).

In some embodiments, the processor 902 includes cache memory 904. Depending on the architecture, the processor 902 can have a single internal cache or multiple levels of internal cache. In some embodiments, the cache memory is shared among various components of the processor 902. In some embodiments, the processor 902 also uses an external cache (e.g., a Level-3 (L3) cache or Last Level Cache (LLC)) (not shown), which may be shared among processor cores 907 using known cache coherency techniques. A register file 906 is additionally included in processor 902 which may include different types of registers for storing different types of data (e.g., integer registers, floating point registers, status registers, and an instruction pointer register). Some registers may be general-purpose registers, while other registers may be specific to the design of the processor 902.

In some embodiments, processor 902 is coupled to a processor bus 910 to transmit communication signals such as address, data, or control signals between processor 902 and other components in system 900. In one embodiment the system 900 uses an exemplary ‘hub’ system architecture, including a memory controller hub 916 and an Input Output (I/O) controller hub 930. A memory controller hub 916 facilitates communication between a memory device and other components of system 900, while an I/O Controller Hub (ICH) 930 provides connections to I/O devices via a local I/O bus. In one embodiment, the logic of the memory controller hub 916 is integrated within the processor.

Memory device 920 can be a dynamic random-access memory (DRAM) device, a Static Random Access Memory (SRAM) device, flash memory device, phase-change memory device, or some other memory device having suitable performance to serve as process memory. In one embodiment the memory device 920 can operate as system memory for the system 900, to store data 922 and instructions 921 for use when the one or more processors 902 executes an application or process. Memory controller hub 916 also couples with an optional external graphics processor 912, which may communicate with the one or more graphics processors 908 in processors 902 to perform graphics and media operations.

In some embodiments, ICH 930 enables peripherals to connect to memory device 920 and processor 902 via a high-speed I/O bus. The I/O peripherals include, but are not limited to, an audio controller 946, a firmware interface 928, a wireless transceiver 926 (e.g., Wi-Fi, Bluetooth), a data storage device 924 (e.g., hard disk drive, flash memory, etc.), and a legacy I/O controller 940 for coupling legacy (e.g., Personal System 2 (PS/2)) devices to the system. One or more Universal Serial Bus (USB) controllers 942 connect input devices, such as keyboard and mouse 944 combinations. A network controller 934 may also couple to ICH 930. In some embodiments, a high-performance network controller (not shown) couples to processor bus 910. It will be appreciated that the system 900 shown is exemplary and not limiting, as other types of data processing systems that are differently configured may also be used. For example, the I/O controller hub 930 may be integrated within the one or more processor 902, or the memory controller hub 916 and I/O controller hub 930 may be integrated into a discreet external graphics processor, such as the external graphics processor 912.

In the following description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

In various embodiments, one or more operations discussed with reference to FIG. 1 et seq. may be performed by one or more components (interchangeably referred to herein as “logic”) discussed with reference to any of the figures. In various other embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine readable or computer-readable media having stored thereon instructions (or software procedures) used to program a computer to perform a process discussed herein. The machine-readable medium may include a storage device such as those discussed with respect to the figures.

The following exemplary and non-limiting embodiments are presented to further illustrate different applications of the disclosed principles. The disclosed principles, however, are not limited the these examples.

Example 1 relates to a system comprising: a processor circuitry and a memory circuitry in communication with the processor circuitry and configured to authenticate communication between a host and an endpoint device through symmetric-based key establishment, the memory circuitry further comprising instructions to cause the processor to: initiate startup at the host by receiving a DeviceId from the device, wherein the DeviceId is used in asymmetric-key cryptography to form a persistent seed Key (SK) between the host and the device; determine whether the DeviceId exists in the secure memory storage and initiate enrollment when the DeviceId is not found in the secure memory storage, the enrolment process further comprising: encrypt the SK with a device storage key (DK) to form a DeviceBlob, send DeviceBlob to the host, and store the DeviceBlob at the secure memory storage of the host; and use symmetric-key cryptography with the SK for authentication and session key establishment.

Example 2 relates to the system of Example 1, wherein the host includes, and the device excludes a secure memory storage device and wherein the DeviceBlob is undefined to the host and wherein the DK is known only to the device firmware.

Example 3 relates to the system of Example 1, wherein encrypting the SK with DK further comprises using DK of the device to wrap the SK and wherein the SK is derived as a function of KDF and r and wherein an integrity key (MK) is derived as a function of KDF and r and wherein SK is encrypted with device storage key (DK) to provide SK(DK) and wherein r is an integer.

Example 4 relates to the system of Example 3, wherein the instructions further comprise instructions to cause the processor to: calculate integrity MAC of (SK)DK with MK to form a device tag and protect integrity of the DeviceBlob (SK)DK during transmission to the host.

Example 5 relates to the system of Example 1, wherein the instructions further comprise instructions to cause the processor to: transmit the DeviceBlob from the host to the device and unwrap DeviceBlob at the device to obtain the SK and wherein the instructions further comprise instructions to cause the processor to: engage the host and the device in symmetric-key cryptography after the device obtains the SK.

Example 6 relates to an apparatus comprising a processor circuitry and a memory circuitry in communication with the processor circuitry to authenticate communication between a host and an endpoint device through symmetric-based key establishment, the memory circuitry further comprising instructions to cause the processor to: initiate startup at the host by receiving a DeviceId from the device, wherein the DeviceId is used in asymmetric-key cryptography to form a persistent seed Key (SK) between the host and the device; determine whether the DeviceId exists in the secure memory storage and initiate enrollment when the DeviceId is not found in the secure memory storage, the enrolment process further comprising: encrypt the SK with a device storage key (DK) to form a DeviceBlob, send DeviceBlob to the host, and store the DeviceBlob at the secure memory storage of the host; and use symmetric-key cryptography with the SK for authentication and session key establishment.

Example 7 relates to the apparatus of Example 6, wherein the host includes, and the device excludes a secure memory storage device and wherein the DeviceBlob is undefined to the host and wherein the DK is known only to the device firmware.

Example 8 relates to the apparatus of Example 6, wherein encrypting the SK with DK further comprises using DK of the device to wrap the SK and wherein the SK is derived as a function of KDF and r and wherein an integrity key (MK) is derived as a function of KDF and r and wherein SK is encrypted with device storage key (DK) to provide SK(DK) and wherein r is an integer.

Example 9 relates to the apparatus of Example 8, wherein the instructions further comprise instructions to cause the processor to: calculate integrity MAC of (SK)DK with MK to form a device tag and protect integrity of the DeviceBlob (SK)DK during transmission to the host.

Example 10 relates to a method comprising: the host initiating startup by receiving a DeviceId from the device, wherein the DeviceId is used in asymmetric-key cryptography to form a persistent seed Key (SK) between the host and the device; determining whether the DeviceId exists in the secure memory storage and initiating enrollment when the DeviceId is not found in the secure memory storage, the enrolment process further comprising: encrypting the SK with a device storage key (DK) to form a DeviceBlob, sending DeviceBlob to the host, and storing the DeviceBlob at the secure memory storage of the host; applying symmetric-key cryptography with the SK for authentication and session key establishment to authenticate communication between the host and the endpoint device.

Example 11 relates to the method of Example 10, wherein the host includes and the device excludes a secure memory storage device.

Example 12 relates to the method of Example 10, wherein the DeviceBlob is undefined to the host.

Example 13 relates to the method of Example 10, wherein the DK is known only to the device firmware.

Example 14 relates to the method of Example 10, wherein encrypting the SK with DK further comprises using DK of the device to wrap the SK.

Example 15 relates to the method of Example 14, wherein the SK is derived as a function of KDF and r and wherein an integrity key (MK) is derived as a function of KDF and r and wherein SK is encrypted with device storage key (DK) to provide SK(DK).

Example 16 relates to the method of Example 15, further comprising calculating integrity MAC of (SK)DK with MK to form a device tag and protecting integrity of the DeviceBlob (SK)DK during transmission to the host.

Example 17 relates to the method of Example 10, further comprising transmitting the DeviceBlob from the host to the device and unwrapping DeviceBlob at the device to obtain the SK and engaging the host and the device in symmetric-key cryptography after the device obtains the SK.

Example 18 relates to a non-transitory computer-readable medium including instructions to authenticate communication between a host and an endpoint device through symmetric-based key establishment, which when executed on a processor cause the processor to implement operations comprising: initiate startup at the host by receiving a DeviceId from the device, wherein the DeviceId is used in asymmetric-key cryptography to form a persistent seed Key (SK) between the host and the device; determine whether the DeviceId exists in the secure memory storage and initiate enrollment when the DeviceId is not found in the secure memory storage, the enrolment process further comprising: encrypt the SK with a device storage key (DK) to form a DeviceBlob, send DeviceBlob to the host, and store the DeviceBlob at the secure memory storage of the host; and use symmetric-key cryptography with the SK for authentication and session key establishment.

Example 19 relates to the medium of Example 18, wherein the host includes and the device excludes a secure memory storage device.

Example 20 relates to the medium of Example 18, wherein the DeviceBlob is undefined to the host.

Example 21 relates to the medium of Example 18, wherein the DK is known only to the device firmware.

Example 22 relates to the medium of Example 18, wherein encrypting the SK with DK further comprises using DK of the device to wrap the SK.

Example 23 relates to the medium of Example 22, wherein the SK is derived as a function of KDF and r and wherein an integrity key (MK) is derived as a function of KDF and r and wherein SK is encrypted with device storage key (DK) to provide SK(DK).

Example 24 relates to the medium of Example 23, further comprising calculating integrity MAC of (SK)DK with MK to form a device tag and protecting integrity of the DeviceBlob (SK)DK during transmission to the host.

Example 25 relates to the medium of Example 18, further comprising transmitting the DeviceBlob from the host to the device and unwrapping DeviceBlob at the device to obtain the SK and engaging the host and the device in symmetric-key cryptography after the device obtains the SK.

While the principles of the disclosure have been illustrated in relation to the exemplary embodiments shown herein, the principles of the disclosure are not limited thereto and include any modification, variation or permutation thereof.

What is claimed is:

1. A system comprising:
a processor circuitry and a memory circuitry in communication with the processor circuitry and configured to authenticate communication between a host and an endpoint device through symmetric-based key establishment, the memory circuitry further comprising instructions to cause the processor to:
initiate startup at the host by receiving a DeviceId from the device, wherein the DeviceId is used in asymmetric-key cryptography to form a persistent seed Key (SK) between the host and the device;
determine whether the DeviceId exists in the secure memory storage and initiate enrollment when the DeviceId is not found in the secure memory storage, the enrolment process further comprising:
encrypt the SK with a device storage key (DK) to form a DeviceBlob,
send DeviceBlob to the host, and
store the DeviceBlob at the secure memory storage of the host; and
use symmetric-key cryptography with the SK for authentication and session key establishment.

2. The system of claim 1, wherein the host includes, and the device excludes a secure memory storage device and wherein the DeviceBlob is undefined to the host and wherein the DK is known only to the device firmware.

3. The system of claim 1, wherein encrypting the SK with DK further comprises using DK of the device to wrap the SK and wherein the SK is derived as a function of KDF and r and wherein an integrity key (MK) is derived as a function of KDF and r and wherein SK is encrypted with device storage key (DK) to provide SK(DK) and wherein r is an integer.

4. The system of claim 3, wherein the instructions further comprise instructions to cause the processor to: calculate integrity MAC of (SK)DK with MK to form a device tag and protect integrity of the DeviceBlob (SK)DK during transmission to the host.

5. The system of claim 1, wherein the instructions further comprise instructions to cause the processor to: transmit the DeviceBlob from the host to the device and unwrap DeviceBlob at the device to obtain the SK and wherein the instructions further comprise instructions to cause the processor to: engage the host and the device in symmetric-key cryptography after the device obtains the SK.

6. An apparatus comprising a processor circuitry and a memory circuitry in communication with the processor circuitry to authenticate communication between a host and an endpoint device through symmetric-based key establishment, the memory circuitry further comprising instructions to cause the processor to:
initiate startup at the host by receiving a DeviceId from the device, wherein the DeviceId is used in asymmetric-key cryptography to form a persistent seed Key (SK) between the host and the device;
determine whether the DeviceId exists in the secure memory storage and initiate enrollment when the DeviceId is not found in the secure memory storage, the enrolment process further comprising:
encrypt the SK with a device storage key (DK) to form a DeviceBlob,
send DeviceBlob to the host, and
store the DeviceBlob at the secure memory storage of the host; and
use symmetric-key cryptography with the SK for authentication and session key establishment.

7. The apparatus of claim 6, wherein the host includes, and the device excludes a secure memory storage device and wherein the DeviceBlob is undefined to the host and wherein the DK is known only to the device firmware.

8. The apparatus of claim 6, wherein encrypting the SK with DK further comprises using DK of the device to wrap the SK and wherein the SK is derived as a function of KDF and r and wherein an integrity key (MK) is derived as a function of KDF and r and wherein SK is encrypted with device storage key (DK) to provide SK(DK) and wherein r is an integer.

9. The apparatus of claim 8, wherein the instructions further comprise instructions to cause the processor to: calculate integrity MAC of (SK)DK with MK to form a device tag and protect integrity of the DeviceBlob (SK)DK during transmission to the host.

10. A method comprising:
the host initiating startup by receiving a DeviceId from the device, wherein the DeviceId is used in asymmetric-key cryptography to form a persistent seed Key (SK) between the host and the device;
determining whether the DeviceId exists in the secure memory storage and initiating enrollment when the DeviceId is not found in the secure memory storage, the enrolment process further comprising:
encrypting the SK with a device storage key (DK) to form a DeviceBlob,
sending DeviceBlob to the host, and
storing the DeviceBlob at the secure memory storage of the host;
applying symmetric-key cryptography with the SK for authentication and session key establishment to authenticate communication between the host and the endpoint device.

11. The method of claim 10, wherein the host includes and the device excludes a secure memory storage device.

12. The method of claim 10, wherein the DeviceBlob is undefined to the host.

13. The method of claim 10, wherein the DK is known only to the device firmware.

14. The method of claim 10, wherein encrypting the SK with DK further comprises using DK of the device to wrap the SK.

15. The method of claim 14, wherein the SK is derived as a function of KDF and r and wherein an integrity key (MK) is derived as a function of KDF and r and wherein SK is encrypted with device storage key (DK) to provide SK(DK).

16. The method of claim 15, further comprising calculating integrity MAC of (SK)DK with MK to form a device tag and protecting integrity of the DeviceBlob (SK)DK during transmission to the host.

17. The method of claim 10, further comprising transmitting the DeviceBlob from the host to the device and unwrapping DeviceBlob at the device to obtain the SK and engaging the host and the device in symmetric-key cryptography after the device obtains the SK.

18. A non-transitory computer-readable medium including instructions to authenticate communication between a host and an endpoint device through symmetric-based key establishment, which when executed on a processor cause the processor to implement operations comprising:
initiate startup at the host by receiving a DeviceId from the device, wherein the DeviceId is used in asymmetric-key cryptography to form a persistent seed Key (SK) between the host and the device;
determine whether the DeviceId exists in the secure memory storage and initiate enrollment when the DeviceId is not found in the secure memory storage, the enrolment process further comprising:
encrypt the SK with a device storage key (DK) to form a DeviceBlob,
send DeviceBlob to the host, and
store the DeviceBlob at the secure memory storage of the host; and
use symmetric-key cryptography with the SK for authentication and session key establishment.

19. The medium of claim 18, wherein the host includes and the device excludes a secure memory storage device.

20. The medium of claim 18, wherein the DeviceBlob is undefined to the host.

21. The medium of claim 18, wherein the DK is known only to the device firmware.

22. The medium of claim 18, wherein encrypting the SK with DK further comprises using DK of the device to wrap the SK.

23. The medium of claim 22, wherein the SK is derived as a function of KDF and r and wherein an integrity key (MK) is derived as a function of KDF and r and wherein SK is encrypted with device storage key (DK) to provide SK(DK).

24. The medium of claim 23, further comprising calculating integrity MAC of (SK)DK with MK to form a device tag and protecting integrity of the DeviceBlob (SK)DK during transmission to the host.

25. The medium of claim 18, further comprising transmitting the DeviceBlob from the host to the device and unwrapping DeviceBlob at the device to obtain the SK and engaging the host and the device in symmetric-key cryptography after the device obtains the SK.
